(19) United States
(12) Patent Application Publication
(10) Pub. No.: US 2012/0270573 A1
(43) Pub. Date: Oct. 25, 2012

(54) POSITIONING SYSTEM AND METHOD FOR SINGLE AND MULTILEVEL STRUCTURES

(75) Inventors: Joshua L. Marti, Bellevue, WA (US); Keane D. Watterson, Seattle, WA (US); Jonathan A. Croy, Seattle, WA (US)

(73) Assignee: Point Inside, Inc., Bellevue, WA (US)

(21) Appl. No.: 13/452,646

(22) Filed: Apr. 20, 2012

Related U.S. Application Data
(60) Provisional application No. 61/477,409, filed on Apr. 20, 2011.
(60) Provisional application No. 61/477,427, filed on Apr. 20, 2011.
(60) Provisional application No. 61/477,450, filed on Apr. 20, 2011.

(51) Int. Cl. H04W 24/00

(52) U.S. Cl. 455/457; 455/456.1

(57) ABSTRACT

A system for determining the position of users, stores, products, or brands inside one or more structures, such as a store, shopping center, cruise ship, etc. In some embodiments, the system utilizes an image capture module of a wireless device to capture information relating to an object disposed at a known location. The information regarding the location of the object is used to provide navigation information, product information, advertising information, and the like to the user while inside the structure. In other embodiments, a positioning system capable of determining the locations of RF signal sources within one or more structures and then using the determined locations of the RF signal sources to determine locations of users' wireless devices is provided.

### CROSS REFERENCE TO RELATED APPLICATIONS

This application claims priority to U.S. Provisional Application No. 61/477,450, filed on Apr. 20, 2011, entitled “CAMERA BASED POSITIONING SYSTEM AND METHOD FOR SINGLE AND MULTI LEVEL STRUCTURES,” U.S. Provisional Application No. 61/477,427, filed on Apr. 20, 2011, entitled “POSITIONING SYSTEM AND METHOD FOR SINGLE AND MULTI LEVEL STRUCTURES,” and U.S. Provisional Application No. 61/477,409, filed on Apr. 20, 2011, entitled “MAP AND NAVIGATION SYSTEM AND METHOD FOR STRUCTURES,” each of which are hereby incorporated by reference in their entirety as if set forth in full herein.

### FIELD OF THE INVENTION

The present invention relates generally to positioning systems, and more particularly, to position determination systems for wireless devices within single and multilevel structures.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Today, position determination is used for mapping and navigation functions in outdoor environments, but is typically not used in indoor environments. Generally, this is because the accuracy of indoor position determination systems relative to an elliptical model of the Earth is not representative of a wireless device's true latitude and longitude. Positioning systems, such as global positioning systems (GPS), Wi-Fi, or cell trilateration systems are rendered ineffective when single and multilevel structures amplify the error in the resulting position due to multi-path, signal attenuation, and inaccurate locations of the RF signal sources used in the position determination calculations. The outdoor maps and navigation systems can tolerate this error due to the great distances between the points of interest used to mark objects on this elliptical model. These outdoor systems were designed as a 2-D system, whereas a structure or collection of structures commonly have several levels and need 3-D position capability. Indoor map and navigation systems require a higher resolution of position determination in the horizontal plane and the vertical plane, commonly described as a floor plan location in the horizontal plane and a floor number or level number in the vertical plane in a structure. Because GPS and cell signals typically lack precise time resolution and attenuate over great distances to reach a wireless receiver of a wireless device, they do not provide the measurement resolution needed for indoor position determination.

Wi-Fi, Near Field Communications, RFID, Bluetooth, and ultra-wideband (UWB) are just some of the RF systems that offer signal measurement diversity and resolutions capable of providing the necessary position determination accuracy for single and multilevel structures. However, there are at least three problems in today's position determination systems that service single and multilevel structures. The first problem is the inaccurate locations of RF signal sources used in the measurements that are fed into a position determination calculation. This beacon source location inaccuracy is transferred through the system into the resulting position determination and often causes very inaccurate results. The second problem is the inaccurate locations of the receiver used to gather signal source measurements that are subsequently used in determining the position of a wireless device of a user belonging to the system. This measurement source location inaccuracy is transferred through the system into the resulting position determination and often causes very inaccurate results. The third problem is the inaccurate, and often missing, floor or level number information in the resultant position. This prevents applications from determining the true points of interest around the location of wireless receivers inside a single or multilevel structure.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 illustrates a block diagram of a positioning system according to an embodiment of the present invention;

FIG. 2 illustrates a process for geocoding metadata about a store, service, product, or brand location using the positioning system of FIG. 1;

FIG. 3A illustrates a first portion of a process for determining the position of a wireless device, user, store, service, product, or brand within a structure or group of structures using the positioning system of FIG. 1;

FIG. 3B illustrates a second portion of the process for determining the position of a wireless device, user, store, service, product, or brand within a structure or group of structures using the positioning system of FIG. 1;

FIG. 4 illustrates a process for assigning the position of a user and RF receiver usable for gathering measurements and information attributed to metadata, radio frequency (RF) transmitters, or signal sources;

FIG. 5 illustrates a process for determining the position of an RF transmitter for subsequent use in determining the position of a wireless receiver belonging to a user of the system;

FIG. 6 illustrates a process for determining the position of a wireless receiver belonging to a user of the system;

FIG. 7 is a schematic diagram illustrating the position determination of a user of an RF receiver and reverse trilateration of an RF signal source.

FIG. 8 is a schematic diagram of an exemplary computer hardware and operating environment in which the systems described herein may be implemented.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

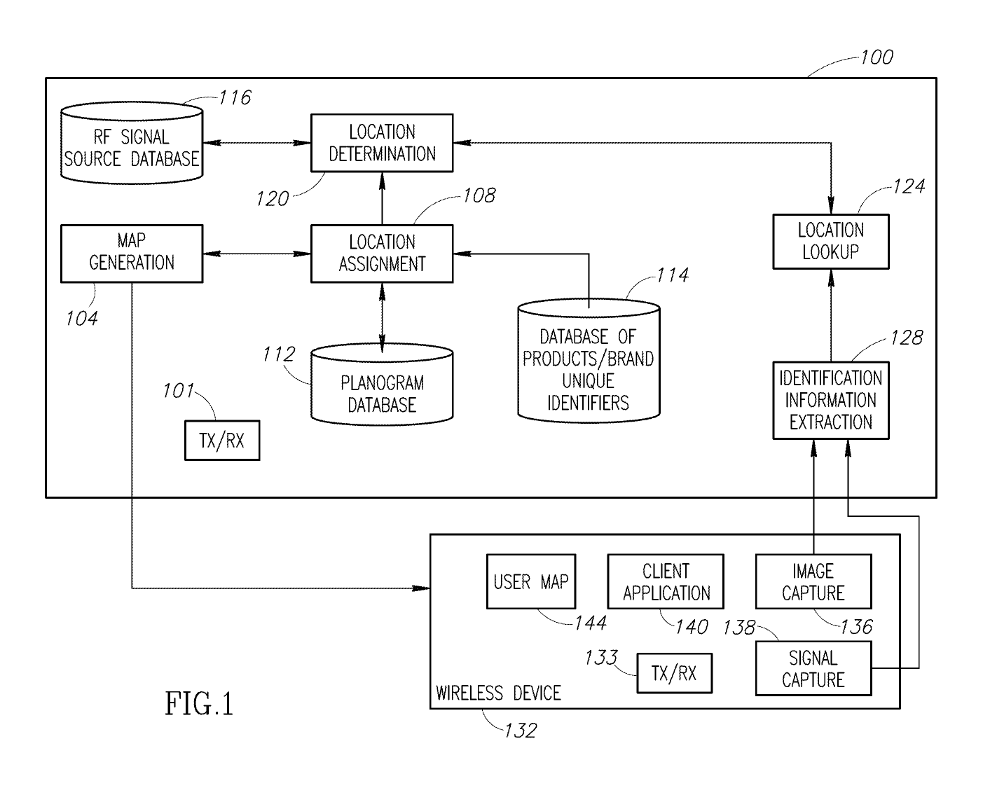

The problem of single or multilevel structure position determination, mapping, and navigation for a single structure or collection of structures is referred to herein as indoor positioning, mapping, and navigation. In a first embodiment described herein with reference to FIGS. 1, 2, 3A, and 3B, obtaining metadata about a location, brand, or product, may be done using image processing techniques to identify a logo or to scan a linear, matrix 2D, or encoded image barcode, and is referred to as barcode scanning or logo identification. Any descriptive or identifiable information about a store, service, logo, product, barcode, URL, person, point of interest (POI), or other objects within structures such as shopping malls, airports, retail stores, stadiums, tradeshows or other venues is referred to as metadata. The process and result for finding a person, place, or item of interest with respect to a geodetic datum is referred to as location determination or position determination. Generally, location and position represent points in space where some object or person can be found.

Embodiments of the present invention are directed to position determination systems (or “positioning systems”) for wireless devices within single and multilevel structures. One embodiment of a positioning system 100 is shown in FIG. 1. In this embodiment, the system 100 is configured for operative communication with a plurality of wireless devices, such as a wireless device 132, over one or more wireless and/or wired communication networks. To achieve this communication capability, the system 100 is configured with one or more transmitter/receiver circuits 132 operative to transmit to and receive data from the wireless devices 132. Similarly, the wireless devices 132 include one or more transmitter/receiver circuits. As an example, the wireless device 132 may comprise a smart phone, tablet computer, digital display, etc. Although the wireless device 132 is shown as a single device, it should be appreciated that the system 100 is configured to operate with numerous wireless devices 132.

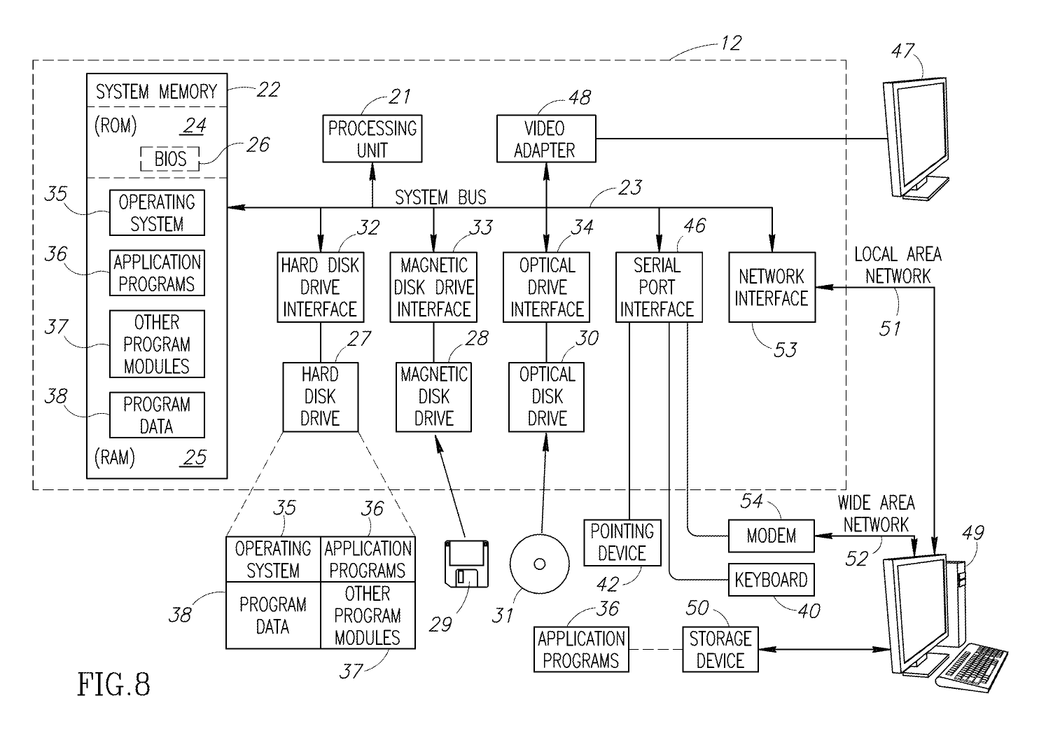

As shown in FIG. 1, the system 100 comprises a plurality of applications or “modules” executable on one or more computers, such as one or more servers, one or more wireless devices 132, or any combinations thereof. For example, the system 100 may be embedded in the wireless device 132 or can be co-located in any system similar to the one shown in FIG. 8. It should be appreciated that the various modules of the system 100 may be logically or physically implemented and/or combined in a plurality of ways, and that the invention is not limited to the particular arrangement shown in FIG. 1. Each of the various modules of the system 100 is described below.

The system 100 comprises a map generation application or module 104 configured for creating a latitude and longitude (and altitude) framework for a structure or set of structures, such as a store, shopping center, cruise ship, etc. (i.e., a reference geodetic datum). The map generation module 104 comprises a cartography application that allows the system 100 to generate a grid of latitude, longitude, and altitude that defines one or more structures' alignment with a common coordinate system, namely the World Geodetic System (WGS 84). There are numerous of ways to do this. In some embodiments, the system 100 utilizes reference points to pixels in an image as the basis for a coordinate system for a particular structure or structures. In these embodiments, a client application 140 executable on the wireless device 132 provides a display of an image map that allows a user to select any pixel in the image and to assign metadata to that particular latitude, longitude, and altitude that corresponds to the pixel.

The system 100 also comprises a location assignment module 108 configured for receiving product location information from a planogram storage or inventory management system 112 associated with the structure and for converting the product location information to a latitude, longitude, and altitude (or a latitude, longitude, and level number). Generally, the planogram storage 112 may comprise a diagram or model that indicates the placement of products within a structure (e.g., aisle information, shelf information, etc.). The metadata, referenced above, may be in the form of a universal product code (UPC), arbitrary planogram code, shelf, aisle, peg, brand, category, or any other non-latitude/longitude data that, through the user interface of the client application 140, may be assigned a pixel location and thereby a latitude/longitude. The latitude/longitude data is then available for any future metadata-to-latitude/longitude translation required by the system 100.

The system 100 is also configured to receive data from the wireless device 132, which comprises an image capture module 136 configured for taking a picture and storing it in a data storage. As shown, the image capture module 136 may be as simple as a standard camera included as part of a mobile phone or as complex as a camera mounted on a data collection unit specifically designed to capture images of products in every aisle or section of a structure, such as a shopping center or a large format retail store.

The system 100 is also configured to receive data from the wireless device 132, which comprises an RF signal capture module 138 configured for gathering signal attributes from surrounding transmitters. As shown, the RF signal capture module 138 may be as simple as a standard RF receiver application processor included as part of a mobile phone or as complex as an RF transceiver mounted on a data collection unit specifically designed to capture RF signal attributes of surrounding transmitters in every aisle or section of a structure, such as a shopping center or large format retail store.

The system 100 also comprises an identification information extraction module 128 configured for extracting product and/or brand identifiable information from an image captured by the image capture module 136 or configured for extracting identifiable information from a RF signal source (e.g., originating from the RF signal capture module 138). The module 128 may reside on the wireless device 132, the system 100, or may be provided by an external system or service. The identification information extraction module 128 may comprise a scanner that receives an image from the image capture module 136 and, through image processing, is able to extract a UPC or other barcode or product identifier. In some embodiments, the identification information extraction module 128 may comprise a custom application that extracts a brand logo out of an image captured by the image capture module 136. Alternatively, the identification information extraction module 128 may comprise an application that receives data that contains RF signal source information and, through data lookup or data parsing, is able to extract RF signal source identification information.

In some embodiments, the identification information extraction module 128 may resolve one or more signal source identifiers that may then be looked up and translated into a latitude/longitude pair. To achieve this, the system 100 may comprise a location lookup module 124 and a location determination module 120. These modules 120 and 124 are operative to translate the signal source identification and measurement information (e.g., MAC, RSSI, SSID, Name, IP Address, Unique ID, etc.) into a latitude and longitude pair. The modules 120 and 124 perform “lookups” to combine any combination of identifiable and measurement information from RF signal sources with a database 116 of RF signal source reports and latitude/longitudes (labeled “RF Signal Source Database 116) to determine the current latitude/longitude of the user, which corresponds to the location of the signal attributes captured by the RF signal capture module 138 of the wireless device 132.

In some embodiments, the identification information extraction module 128 may resolve an image into one or more keywords that may then be looked up and translated into a latitude/longitude pair. To achieve this, the modules 120 and 124 are also operative to translate the product/brand identifiable information (e.g., UPC, product or brand name, product or brand logo, stock-keeping unit (SKU), global trade item number (GTIN), etc.) into a latitude and longitude pair. The modules 120 and 124 perform “lookups” to combine any combination of identifiable information for products, brands, UPCs, and/or categories with the planogram information and the latitude/longitude map of a structure to determine the current latitude/longitude of the user, which corresponds to the location of the product of interest captured by the image capture module 136 of the wireless device 132.

The system 100 also includes a user map module 144 executable on the wireless device 132 configured to place a “pin” on a map and to initialize the user's position at the latitude/longitude of a previous translation, a manual selection of a geocoded pixel or landmark from a list. The user map module 144 may be a component of the client application 140 and, more generally, may comprise an application on a smart phone, a kiosk, or a printout that plots the latitude/longitude from previous lookups onto a map for easier navigation to and from any point of interest (POI) in the structure, including a user's current location and the location of a product or item of interest.

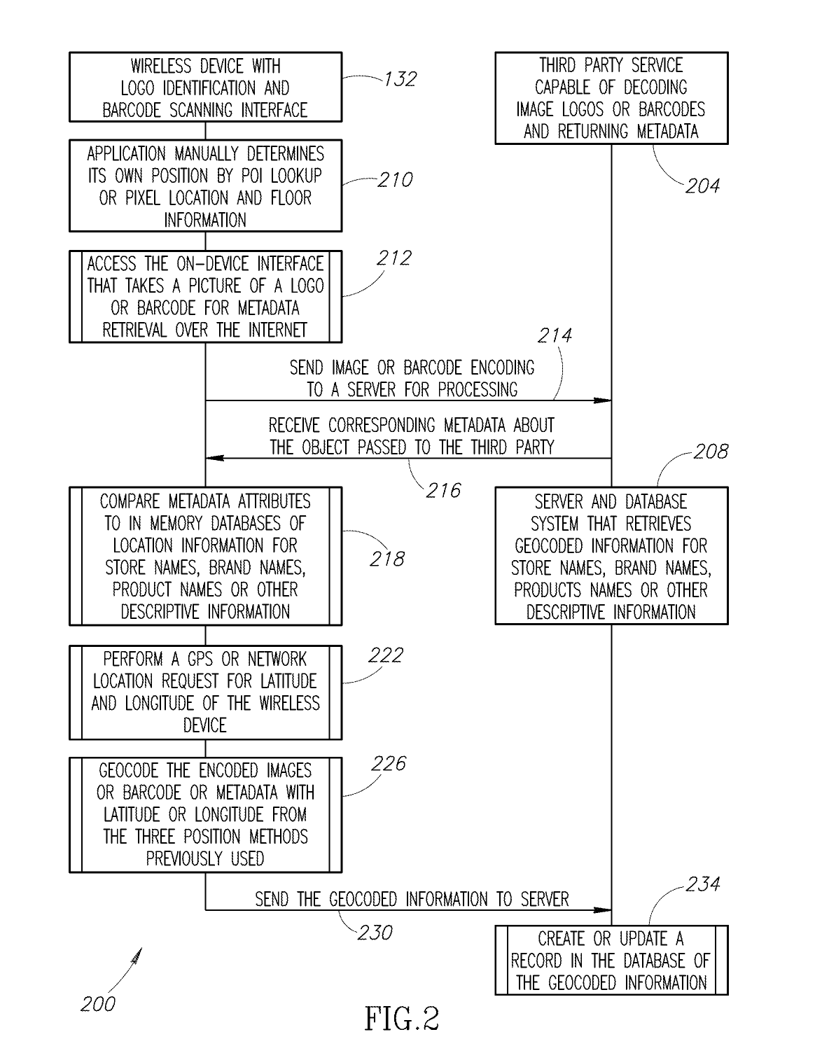

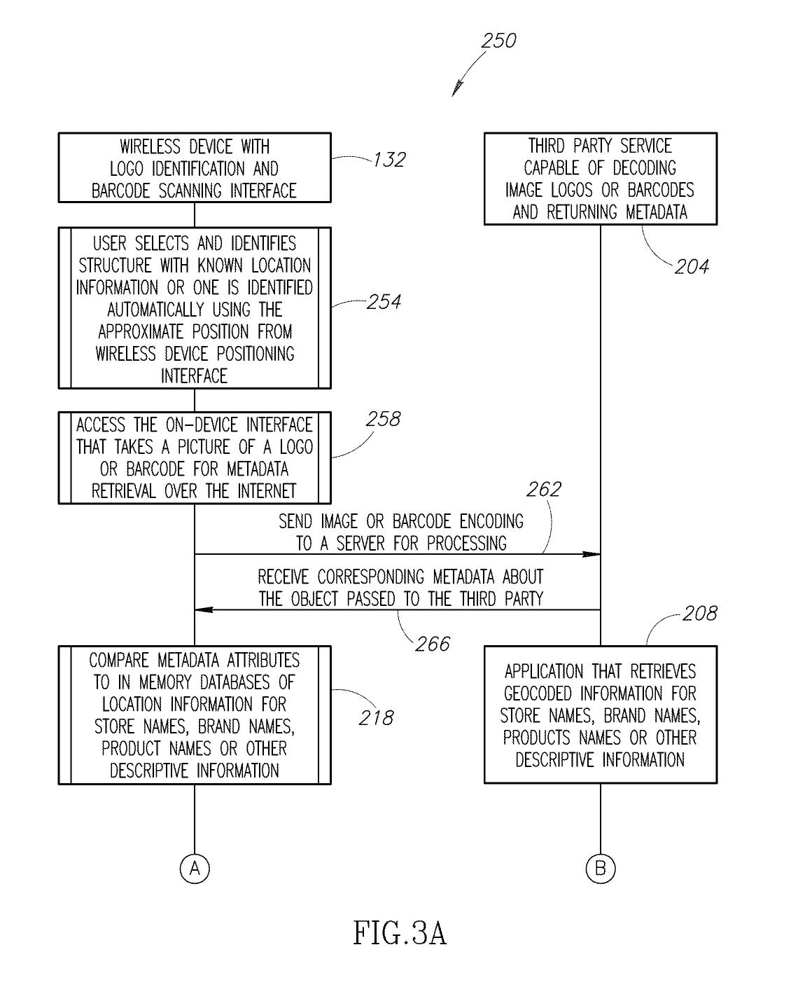

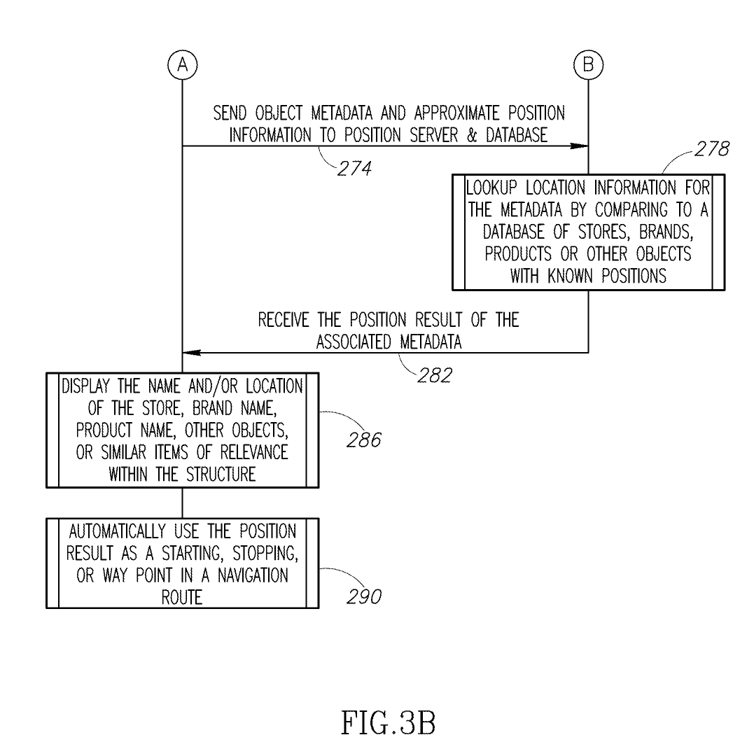

FIGS. 2, 3A, and 3B illustrate processes for utilizing the system 100 to determine the position of the wireless device 132 (and other wireless devices) using a camera and image processing techniques to determine information data, such as barcode or logo metadata of products, URLs, and locations inside one or more indoor structures. As described above, the captured and processed information data may be compared to a catalog of store names, brand names, product names, or other descriptive information to determine the position of the wireless device 132 based on known positions for such items. The system 100 can then return the position of the wireless device 132 and the user, similar stores, brands, or products.

To determine the position of the wireless device 132, the system 100 needs to have geocoded location information tied to store names, brand names, and products within the structure and the capability to identify the logo or scan a barcode and return metadata associated with the object, whether it is a store name, brand name, or product name or description. The modules for providing this capability are discussed above. In some embodiments, the geodetic datum used for the structures and geocoded store names, brand names, and products can be the same one shared with the Earth's elliptical model (e.g., WGS 84), or may be a unique geodetic datum. For example, it may be desirable to utilize a unique datum in the case where the structure comprises a cruise ship, train, or other moving reference frame. Once the metadata is retrieved (e.g., from a barcode scan using the wireless device 132), it can be compared using a keyword filter or a search of synonyms to the catalog of geocoded store names, brand names, product names, or other descriptive information. Then, the position of the wireless device 132 may be determined based on known positions for such items. Similarly, the system 100 may return the location of similar stores, brands, or products in addition to the wireless device 132 and user's location. The method of determining the position of any of these items of interest is illustrated in FIGS. 3A and 3B and is described below.

FIG. 2 illustrates a process 200 for geocoding metadata returned from identifying a logo or scanning a barcode associated with a store, service, product or brand within a structure or group of structures, and storing the geocoded data in an application 208. It should be appreciated that the steps in the process 200 or other processes described herein may not necessarily be performed in the order shown or described. The process 200 may be implemented by users associated with the entity providing the system 100, for example, during setup of the system. In order to geocode the metadata of a product, the system 100 needs to first determine the user's location, and hence the location of the wireless device 132 in proximity to the logo image and/or barcode of the product being identified.

The system 100 may use one or more methods alone or in combination to determine the location of the wireless device 132 in proximity to the item of interest. One method is to have the user manually select a nearby landmark that the user can uniquely identify or a geocoded pixel location on a map image displayed on the wireless device 132 and record the landmark or pixel position, thereby identifying the structure and floor or level information in the process, block 210.

A second method is to compare metadata keywords to a database 114 (see FIG. 1) of geocoded stores, products, and/or brands, and to select the most probable match and location, block 218. This may be accomplished by accessing the on-device interface of the wireless device 132 and capturing an image of a logo or barcode of a product or item of interest, block 212. The image or barcode encoding may be sent to a service 204 capable of decoding image logos or barcodes and returning metadata that may be used for the comparison, arrows 214 and 216. The service 204 may be part of the system 100 or may be a third party service.

A third method is to manually or automatically request that a GPS or network-based position be determined and to record the result, block 222. In some embodiments, some or all available position information and corresponding metadata from the logo or barcode are combined into a transmission to the application 208 where a record is created or updated for use by the system 100, blocks 226 and 234, and arrow 230.

FIGS. 3A and 3B illustrate a process 250 for determining and displaying the user's position or the position of items or points of interest within a structure.

The user first selects and identifies a structure (e.g., a store) with known location information. Alternatively, a structure is identified automatically using the approximate position from a positioning interface (e.g., GPS) of the user's wireless device 132, block 254. Next, the user utilizes the image capture module 136 of the wireless device 132 to take a picture of a logo or barcode for an item of interest within the structure, block 258. The image or barcode encoding may then be sent from the wireless device 132 to the service 204 capable of decoding the image logo or barcode and returning metadata about the item to the wireless device 132, actions 262 and 266.

Once the logo or barcode information has been decoded into more descriptive metadata, the wireless device 132 can access a local or networked database and compare the metadata with geocoded records of similar keyword metadata, block 218. The wireless device 132 may send the metadata for the object of interest to the application 208, where the server and database retrieve location information for the metadata by comparing it to a database of stores, brands, products, or other objects with known positions, arrows 274 and 282, and block 278. In some embodiments, the search for a match may be enhanced by using approximate position information received from the wireless device 132 to filter down a list of potential items to items of relevance based on location. Once an exact match or set of similar matches are identified, the wireless device 132 may display the location of the user, item of interest, similar items of interest surrounding the user, or the like, block 286. Example scenarios for using the system 100 are described below.

As shown in FIG. 3B at block 290, the system 100 is also operative to utilize the user's position or the position of items or points of interest in a structure as navigation starting points, stopping points, or waypoints along a navigation path. This allows the user to receive “turn-by-turn” directions to and from any item associated with the position result of an image identification or barcode scan.

Three examples of the operation of the system 100 are provided below. These examples are provided for explanatory purposes and should not be considered limiting in any way.

In a first example, a user may walk into a store and find a blouse that she would like to receive for herself as a birthday present. She may take a picture of a barcode of the blouse using the image capture module 136 of the wireless device 132. Using the wireless device 132, the user may then send a message (e.g., SMS message, etc.) to her mother (or other person) telling her mother that she has found the blouse and would like to receive it for her birthday. The message may include the image of the barcode. Subsequently, when the user's mother enters into the store that is selling the desired blouse, the mother uses the client application 140 to extract the identifiable information in the picture (e.g., the barcode for the blouse, logo information, etc.). This may be done by selecting the picture sent by the user from within the application 140. The user map module 144 may then display a map of the store with a “pin” located where that particular blouse is located in the store. If the mother wants to see the most direct route to get to the blouse, she may then scan a barcode of any item around her using the image capture module 136 of her wireless device 132. At that moment, using the methods described above, the system 100 determines where the mother's approximate location is in the store and can route the quickest path to the item (e.g., the blouse) she is looking to purchase. A graphical depiction of the route information may then be provided to the mother via the display of her wireless device 132.

In a second example, a user has generated and saved a “shopping list” using the client application 140 of the system 100. The user may then enter a store to do her weekly shopping. While in the personal care section of the store, the system 100 may cause a message to be displayed on the user's wireless device 132 that prompts her to “scan any barcode to get a special offer.” For example, the user may then scan a personal care product, such as cotton swabs. Having already determined the location of the user, the client application 140 then runs a query around the user's location to identify any sale promotions currently offered for products in that section of the store. Offers for one or more products may then be presented to the user for display on her wireless device 132.

In some embodiments, the system 100 may be operative to recognize that a particular product (e.g., mouthwash) is on the user's shopping list, and to specifically tailor the list of nearby offers presented to the user according to the shopping list or other known user preferences. In this example, the application 140 may display offers for mouthwash products when the user is in the personal care section, since the application knows mouthwash is on the user's shopping list. In addition to providing a list of one or more offers, the application 140 may also provide a map of the products' current location, and may provide routes for the quickest path to the products from the user's current location.

In a third example, a user is in an unfamiliar store searching for diapers (or any other product). The user opens the application 140 on his wireless device 132 and scans the nearest barcode around him using the image capture module 136 of the wireless device. After translating the barcode to a location inside the store, the application 140 then displays an icon on a map showing the user his current location in the store.

The user may then perform a search for diapers using the application 140 by, for example, typing the word “diapers” into a search bar. The application 140 responds by providing a marker on the map identifying where diapers are located in the store. The application 140 also determines and displays the fastest route for the user to take to get to the diapers from his current location in the store. Once the user is at the location of the diapers, the application 140 may recognize what section of the store he is in using a suitable positioning technology (e.g. Wi-Fi, Bluetooth, GPS, etc.).

Using this location information, the application 140 may display an advertisement or promotional offer that pertains to products available in the section of the store where the user is current located. In this example, an advertisement for diaper rash ointment may be displayed, since the system knows the user is interested in purchasing diapers, a related product. When viewing the advertisement, the user may remember that he is running low on diaper rash ointment and may select the product displayed in the advertisement (e.g., by “tapping” on the screen of the wireless device 132). The application 140 may then provide a marker on the map showing the user where the diaper rash ointment is located and the route for the quickest path for the user given the user's current location.

The advantages of this embodiment include, without limitation, providing the ability to identify positions of wireless devices, the users of the wireless devices, and similar stores, brands, or products by taking a picture of a logo or decoding a barcode and using identified metadata to filter a list of possible locations within an indoor structure or group of structures. The position determination service enables the system 100 to set a starting point for navigation to any known location with step-by-step directions, maps, and visual cues displayed on the fixed or portable wireless device 132. The position determination provides users the ability to find similar items of relevance located nearby their locations.

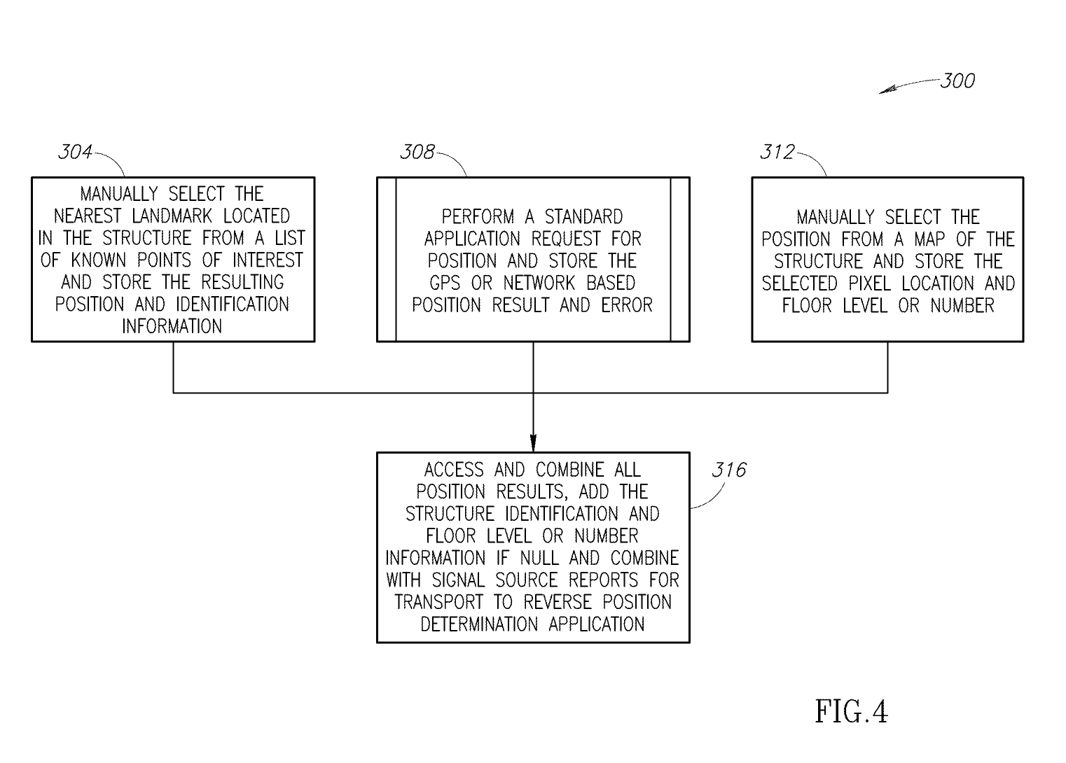

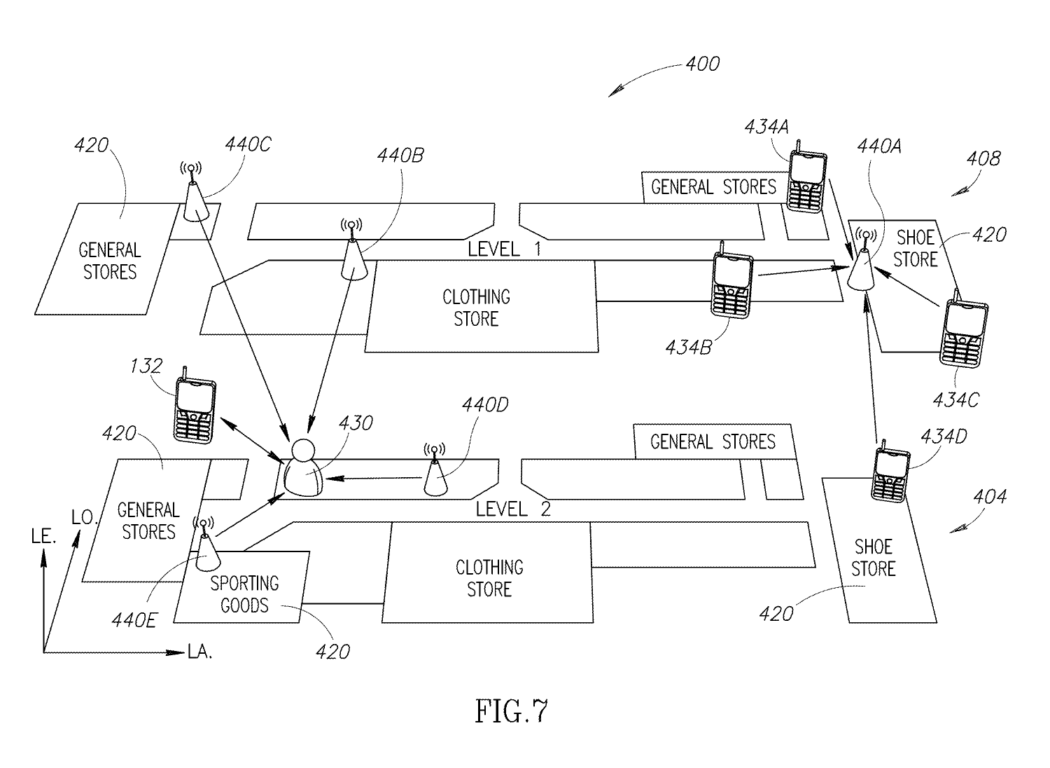

FIGS. 4-7 illustrate the operation of another embodiment of the present invention. In this embodiment, the system 100 is capable of determining the position of RF signal sources (e.g., RF signal sources 440A-E shown in FIG. 7) and capable of using the determined positions for the RF signal sources to then determine the positions of user wireless devices 132 (e.g., the RF receivers 132 and 434A-D shown in FIG. 7) listening to the RF signal sources. As a non-limiting example, the RF signal sources may comprise Wi-Fi access points, Bluetooth transmitters, and the like. By determining the positions of the users' wireless devices 132 according to this embodiment, the system 100 may perform similar functions including navigation, mapping, advertising, and the like, as discussed above with reference to FIGS. 1, 2, 3A, and 3B.

Referring to FIG. 7, an exemplary structure 400 having a lower level 404 and an upper level 408 is shown. The structure 400 is in the form of a two story shopping center and includes a plurality of stores 420. The structure 400 includes a plurality of RF signal sources 440A-E fixedly positioned at various locations throughout the structure on both the lower level 404 and the upper level 408. As shown in the bottom left corner of FIG. 7, the structure 400 extends in three dimensions, namely, latitude (LA.), longitude (LO.), and level number (LE.).

In order to determine the position of the RF signal sources 440A-E, signal measurements from the RF receivers 434A-434D are gathered when the RF receivers are positioned within the structure 400 by using methods shown in FIGS. 3, 4 and 6. Depending on the orthogonality of these signal measurements, three or more discrete points may need to be gathered from where the measurements were made. As shown in FIG. 7, one or more RF receivers 434A-D make the signal measurements and allow the system to reverse trilaterate the position of the RF signal source 440A. A similar procedure may be performed for the other RF signal sources 440B-E located within the structure 400. The geodetic datum used for the structure 400 can be the same one shared with the Earth's elliptical model (e.g., WGS 84) or its own unique datum as in the case of a cruise ship, train, image pixels, or other reference frame. Once the positions of the RF signal sources 440A-E are known, the RF signal sources can be used in a calculation of the position of any wireless device 132 capable of receiving signals from the RF signal sources. In FIG. 7, an example of reverse trilaterating the RF signal source 440A and trilaterating the wireless device 132 of a user 430 is provided. Alternatively, the RF signal source measurement information gathered by the user 430 can be used to calculate his or her position using the closest match of signal strengths corresponding to 440A-E for any position where a device 132 sent its current position and RF signal identification and measurement position 344.

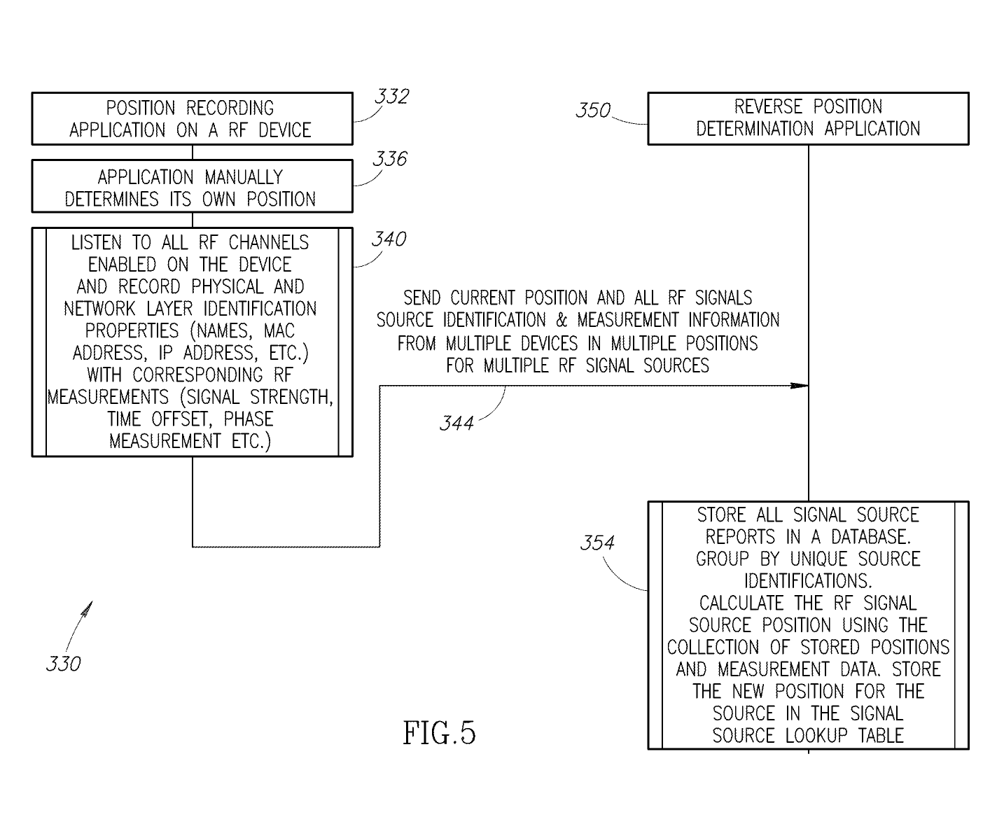

FIG. 4 illustrates a process 300 for manually determining the location of the RF receivers 434A-434D that are configured to record signal source identification and measurements received from an RF signal source (e.g., the RF signal source 440A) when determining the fixed location of the RF signal source. The RF receivers 434A-434D may be operated by one or more persons tasked with configuring the system to work in the structure 400. These persons may be referred to herein as “installers.” One method of determining the location of the RF receivers 434A-434D within the structure 400 is to have the user manually select a nearby landmark the installers can uniquely identify and record the landmark's position identification, thereby identifying the structure 400 and floor or level information in the process, block 304. A second method is to manually or automatically request that a GPS or network-based position be determined from a third party system and record the result and any error associated with the result, block 308. A third method is to have the installers manually select the correct floor level map and a pixel location of the installer's known position using the graphical interface of the RF receiver 434 and recording the result, block 312. Some or all records of the location information for the RF receivers 434A-434D may then be combined into a record used in the process depicted in FIG. 5 to gather enough measurements to reverse trilaterate the position of the RF signal source 440A and the other RF signal sources 440B-440E in the structure 400, block 316.

FIG. 5 illustrates a process 330 for collecting measurements from the RF receivers 434A-434D that are at known positions for the purpose of reverse trilaterating the position of the RF signal source 440A within the structure 400. Each of the RF receivers 434A-434D may execute a position recording application 332. The actual positions of the RF receivers 434A-434D are determined using the process 300 shown in FIG. 4 and described above, block 336. Each of the RF receivers 434A-434D then “listens” to all enabled RF channels and records the physical and network layer identification properties (e.g., name, MAC address, IP address, etc.) and corresponding RF signal measurement characteristics (e.g., signal strength, time offset, phase measurement, etc.) for one or more RF signal sources, block 340. Three or more discrete measurements are needed from the known locations to determine the position of the RF signal source 440A (or other RF signal sources).

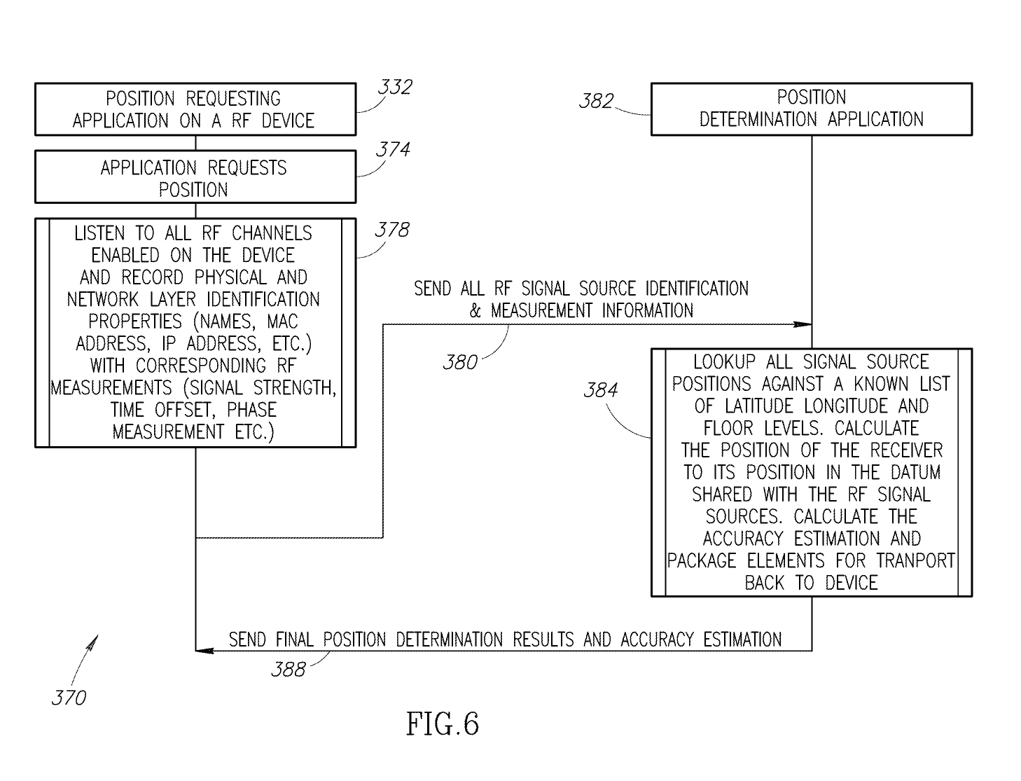

The RF receivers 434A-434D may then send their current position and all RF signal source identification and measurement information to a reverse position determination application 350, as indicated by the arrow 344. The reverse position determination application 350 may store the received signal source reports in a database grouped by unique RF signal source identifications, block 354. Once enough measurements are collected, the reverse position determination application 350 can determine the location of the RF signal sources using any one or more methods known in the art, such as angle of arrival (AOA), time of arrival (TOA), received signal strength indication (RSSI Fingerprinting), and the like. In general, the absolute known positions of the RF receivers 434A-434D and the signals they receive from the RF signal source 440A are used to determine the location of the RF signal source 440A. Once the position of the RF signal source 440A is determined, it is stored in a database for use by a position determination application 382 shown in FIG. 6 and described below.

FIG. 6 illustrates a process 370 for determining the position of an RF receiver of a user, such as the RF receiver 132 of the user 430 shown in FIG. 7. The RF receiver 132 of the user 430 may be used by an application and user to access point of interest (POI) information over a network, as described above with reference to FIGS. 1, 2, 3A, and 3B. The RF receiver 132 may include, but is not limited to cellular devices, Wi-Fi devices, Bluetooth devices, RFID devices, Near Field Communication devices, and Ultra Wide Band (UWB) devices.

FIG. 6 demonstrates how a position requesting application 332 of an RF receiver can request its position from a position determination application 382, block 374. The RF receiver 132 of the user 430 “listens” to all enabled RF channels and records the physical and network layer identification properties (e.g., name, MAC address, IP address, etc.) and corresponding RF signal measurement characteristics (e.g., signal strength, time offset, phase measurement, etc.) received from RF signal sources 440B-440E, block 378. As indicated by the arrow 380, the RF receiver 132 then sends all of the RF signal source identification and measurement information to the position determination application 382. The position determination application 382 is capable of determining the position of the RF receiver 132 by trilaterating the location using a combination of measurements from the RF signal sources (e.g., RF signal sources 440B-440E) with known locations determined by the process 330 of FIG. 5, block 384. Alternatively, the position determination application 382 is capable of determining the position of the RF receiver 132 by resolving one or more RF signal source identifiers and measurements 440B-E into a latitude/longitude pair by performing a lookup of RF signal sources identification and measurement information (e.g., MAC, RSSI, SSID, Name, IP Address, Unique ID, etc.) that resembles a latitude and longitude pair determined by the reports stored during the process 330 of FIG. 5, block 354. The position determination application 382 performs “lookups” to combine any combination of identifiable and measurement information from RF signal sources with the database of RF signal source reports and latitude/longitudes 116 to determine the current latitude/longitude of the user, which corresponds to the location the wireless device 132.

As indicated by the arrow 388, the position determination application 382 may then send the final position determination results and an accuracy estimation to the RF receiver 132.

The advantages of this embodiment include, without limitation, the ability to identify positions of RF signal sources, such as Wi-Fi access points and Bluetooth transmitters, using measurement records previously collected by independent RF receivers and applications. These RF signal source positions are then used for the purpose of creating a service where applications executing on RF receivers can submit a list of received RF signal sources and receive in return their position within the geodetic datum of a structure or collection of structures. This position determination service enables setting a starting point for navigation to any known location with step-by step-directions, maps, and visual cues displayed on a fixed or portable device.

In general, embodiments of the present invention may comprise hardware and software that facilitates the determination of the position of users, stores, products, or brands inside structures. The ability to determine these three dimensional (3D) positions enable single or multilevel structure mapping and navigation services for a single structure or collection of structures, referred to herein as indoor positioning, mapping, and navigation.

A few of the many aspects or embodiments of the present invention are now described.

According to an Aspect A, the invention comprises a computer-implemented method for determining the position of users within a structure, the method comprising: electronically determining position information for a plurality of RF receivers within the structure; electronically measuring signal characteristic information for a plurality of wireless signals received by receiver circuits of the plurality of RF receivers from transmitter circuits of a plurality of RF signal sources fixedly positioned within the structure, wherein at least three RF receivers of the plurality of RF receivers receive wireless signals from each of the plurality of RF signal sources; storing the signal characteristic information and associated position information for the plurality of RF receivers in a computer database; electronically determining the position of each of the plurality of RF signal sources using the stored signal characteristic information and associated position information; storing the position of the plurality of RF signal sources in a computer database; electronically measuring signal characteristic information for a plurality of wireless signals received by a receiver circuit of an RF receiver of a user from at least three of the plurality of RF signal sources; electronically determining the position of the RF receiver of the user using the measured signal characteristic information and the determined position of the plurality of RF signal sources associated with the measured signal characteristic information; and sending via a transmitter circuit the determined position of the RF receiver of the user to the RF receiver of the user.

An embodiment of the invention also comprises Aspect A, wherein determining position information for the plurality of RF receivers within the structure comprises electronically associating each of the plurality of RF receivers with a physical landmark disposed within the structure having a known location stored in a database.

An embodiment of the invention also comprises Aspect A, wherein electronically determining position information for the plurality of RF receivers within the structure comprises displaying a map image of the structure comprising geocoded pixels on a wireless display of the RF receiver of the user, receiving a selection of one or more of the geocoded pixels, and associating the location of the RF receiver of the user with the selected one or more geocoded pixels.

An embodiment of the invention also comprises Aspect A, wherein electronically determining position information for the plurality of RF receivers within the structure comprises receiving a global positioning system (GPS) position of each of the plurality of RF receivers.

According to an Aspect B, the invention comprises a computer-implemented method for determining the position of users within a structure, the method comprising: electronically determining position information for a plurality of RF receivers within the structure; electronically measuring signal characteristic information for a plurality of wireless signals received by receiver circuits of the plurality of RF receivers from transmitter circuits of a plurality of RF signal sources fixedly positioned within the structure, wherein at least three RF receivers of the plurality of RF receivers receive wireless signals from each of the plurality of RF signal sources; storing the signal characteristic information and associated position information for the plurality of RF receivers in a computer database; electronically determining the position of each of the plurality of RF signal sources using the stored signal characteristic information and associated position information; storing the determined positions of the plurality of RF signal sources in a computer database; measuring signal characteristic information for a plurality of wireless signals received by an RF receiver of a user from at least three of the plurality of RF signal sources; electronically determining the position of the RF receiver of the user using the measured signal characteristic information and the determined positions of the plurality of RF signal sources associated with the measured signal characteristic information; and sending via a transmitter circuit the determined position of the RF receiver of the user to the RF receiver of the user.

According to an Aspect C, the invention comprises a computer-implemented method for determining the position of a wireless device of a user within a structure, the method comprising: electronically determining the position of a plurality of RF signal sources by measuring signal characteristic information received by receiver circuits of a plurality of RF receivers from transmitter circuits of the plurality of RF signal sources; storing the position of the plurality of RF signal sources in a computer database; electronically measuring signal characteristic information for a plurality of wireless signals received by a receiver circuit of the wireless device of the user from at least three of the plurality of RF signal sources; electronically determining the position of the wireless device of the user using the measured signal characteristic information and the determined position of the RF signal sources associated with the measured signal characteristic information; and sending via a transmitter circuit at least one of store information, brand information, or product information for display on the wireless device of the user.

According to an Aspect D, the invention comprises an article of manufacture comprising a non-transitory computer readable medium having stored therein components executable by a processor of a computer for performing a process for determining the position of a user within a structure, the process comprising: electronically determining the locations of a plurality of objects positioned within the structure; storing an identification and the determined location information for each of the plurality of objects in a computer database; receiving via a receiver circuit metadata relating to one of the plurality of objects from a transmitter circuit of a wireless device of a user; electronically identifying one of the plurality of objects and its associated location information using the metadata; and sending via a transmitter circuit the location information for the identified object to the wireless device of the user.

### Computing System

FIG. 8 is a schematic diagram of hardware and an operating environment in conjunction with which implementations of the positioning systems described above may be practiced. The description of FIG. 8 is intended to provide a brief, general description of suitable computer hardware and a suitable computing environment in which implementations of the present invention may be practiced. Although not required, implementations are described in the general context of computer-executable instructions, such as program modules, being executed by a computer, such as a personal computer or the like. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, cloud computing architectures, and the like. Implementations may also be practiced in distributed computing environments where tasks are performed by remote processing devices that are linked through one or more communications networks. In a distributed computing environment, program modules may be located in both local and remote memory storage devices.

The exemplary hardware and operating environment of FIG. 8 includes a general-purpose computing device in the form of a computing device 12. The computing device 12 includes the system memory 22, a processing unit 21, and a system bus 23 that operatively couples various system components, including the system memory 22, to the processing unit 21. There may be only one or there may be more than one processing unit 21, such that the processor of computing device 12 comprises a single central-processing unit (CPU), or a plurality of processing units, commonly referred to as a parallel processing environment. The computing device 12 may be a conventional computer, a distributed computer, a mobile computing device, or any other type of computing device.

The system bus 23 may be any of several types of bus structures including a memory bus or memory controller, a peripheral bus, and a local bus using any of a variety of bus architectures. The system memory 22 may also be referred to as simply the memory, and may include read only memory (ROM) 24 and random access memory (RAM) 25. A basic input/output system (BIOS) 26, containing the basic routines that help to transfer information between elements within the computing device 12, such as during start-up, may be stored in ROM 24. The computing device 12 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media. The computing device 12 may also include one or more other types of memory devices (e.g., flash memory storage devices, and the like).

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37 (e.g., one or more of the modules and applications described above), and program data 38. A user may enter commands and information into the computing device 12 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, a universal serial bus (USB), or the like. A monitor 47 or other type of display device is also connected to the system bus 23 via an interface, such as a video adapter 48. In addition to the monitor, computers typically include other peripheral output devices (not shown), such as speakers and printers.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 8 include a local-area network (LAN) 51 and a wide-area network (WAN) 52. Such networking environments are commonplace in offices, enterprise-wide computer networks, intranets and the Internet.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

What is claimed is:

1. A computer-implemented method for determining the position of users within a structure, the method comprising:
electronically determining the locations of a plurality of objects positioned within the structure;
storing an identification and the determined location information for each of the plurality of objects in a computer database;
receiving via a receiver circuit metadata relating to one of the plurality of objects from a wireless device of a user;
electronically identifying one of the plurality of objects and its associated location information using the metadata;
electronically associating the location information of the identified object with a location information of the wireless device of the user; and
sending via a transmitter circuit the location information of the wireless device to a receiver circuit of the wireless device.

2. The method of claim 1, wherein determining the locations of the plurality of objects within the structure comprises electronically associating each of the objects with a physical landmark disposed within the structure having a known location stored in a computer database.

3. The method of claim 1, wherein electronically determining the locations of the plurality of objects within the structure comprises displaying a map image of the structure comprising geocoded pixels on a display of a wireless device, electronically receiving a selection of one or more of the geocoded pixels, and electronically associating the pixel selection with one of the plurality of objects.

4. The method of claim 1, wherein electronically determining the locations of the plurality of objects within the structure comprises electronically receiving a metadata keyword relating to an object, automatically comparing the metadata keyword to a database of geocoded objects, and automatically selecting a probable match for the object based on the comparison.

5. The method of claim 1, wherein electronically determining the locations of the plurality of objects within the structure comprises electronically receiving metadata relating to an object from a wireless device located proximate to the object, electronically receiving a global positioning system (GPS) position of the wireless device, and electronically associating the location of the object with the GPS position.

6. The method of claim 1, wherein receiving metadata relating to one of the plurality of objects from a wireless device of a user comprises electronically receiving via the receiver circuit an image captured by the wireless device, and electronically processing the image to extract logo or barcode information from the image.

7. The method of claim 1, further comprising displaying a map of the structure on a display of the wireless device of the user, and displaying the location of the wireless device of the user on the map.

8. The method of claim 1, further comprising receiving a selection of an object from the user via the wireless device, and displaying a path for the user to travel between the user's current location and the location of the selected object on the wireless device.

9. The method of claim 1, wherein identifying one of the plurality of objects and its associated location information using the metadata comprises electronically comparing the metadata to a set of geocoded objects in a computer database, and utilizing the location of the wireless device to automatically reduce the number of objects in the set of objects that are compared by including only objects located near the approximate location of the wireless device.

10. The method of claim 1, further comprising displaying store, brand, or product information on the wireless device of the user dependent on the determined location of the wireless device.

11. The method of claim 1, further comprising displaying an advertisement on the wireless device of the user dependent on the determined location of the user within the structure.

12. The method of claim 1, wherein the plurality of objects comprises store names, brand names, or product names.

13. The method of claim 1, wherein the metadata comprises a barcode or a brand logo.

14. The method of claim 1, wherein the structure comprises one or more stores.

15. A computer-implemented method for determining the position of users within a structure, the method comprising:
electronically determining the locations of a plurality of objects positioned within the structure;
storing an identification and the determined location information for each of the plurality of objects in a computer database;
receiving via a receiver circuit metadata relating to one of the plurality of objects from a transmitter circuit of a wireless device of a user;
electronically identifying one of the plurality of objects and its associated location information using the metadata; and
sending via a transmitter circuit at least one of store information, brand information, or product information for display on the wireless device of the user.

16. A computer system for providing position information within a structure, the computer system comprising:
a position determination computing system including one or more applications executable thereon and configured to provide an interface for communicating with a plurality of wireless devices over a computer network, the one or more applications being operative to:
electronically determine the locations of a plurality of objects positioned within the structure;
store an identification and the determined location information for each of the plurality of objects in a computer database;
receive metadata over the compute network relating to one of the plurality of objects from a wireless device of a user;
electronically identify one of the plurality of objects and its associated location information using the metadata and object data in a computer database; and
send via the computer network the location information for the identified object to the wireless device.

17. The computer system of claim 16, wherein the one or more applications are executable on the position determination computing system, the plurality of wireless devices, or a combination thereof.

18. A computer system for providing position information for an RF receiver of a user within a structure, the computer system comprising:
a position determination computing system including one or more applications executable thereon and configured to provide an interface for communicating with a plurality of RF receivers over a computer network, the one or more applications being operative to:
electronically determine the position of a plurality of RF signal sources by measuring signal characteristic information received by receiver circuits of a plurality of RF receivers from the RF signal sources;
store the position of the plurality of RF signal sources in a computer database;
electronically measure signal characteristic information for a plurality of wireless signals received by a receiver circuit of the RF receiver of the user from at least three of the plurality of RF signal sources;
electronically determine the position of the RF receiver of the user using the measured signal characteristic information and the determined position of the RF signal sources associated with the measured signal characteristic information; and
send via the computer network at least one of store information, brand information, or product information for display on the RF receiver of the user.
